(19) United States
(12) Patent Application Publication
(10) Pub. No.: US 2007/0250337 A1
(43) Pub. Date: Oct. 25, 2007

(54) ELECTRONIC CONTRACTING

(75) Inventors: Murali M. Karamchedu, Beaverton, OR (US); Jeffrey B. Sponaugle, Tigard, OR (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(73) Assignee: KRYPTIQ CORPORATION, Hillsboro, OR (US)

(21) Appl. No.: 11/739,521

(22) Filed: Apr. 24, 2007

Related U.S. Application Data
(63) Continuation-in-part of application No. 11/365,748, filed on Feb. 28, 2006.

(51) Int. Cl. G06Q 30/00

(52) U.S. Cl. 705/1

(57) ABSTRACT

Embodiments of the present invention provide methods and systems for computer-facilitated construction of contracts, such as health care contracts. Embodiments include the employment of meta data, and handling of inter-dependent and/or mutual exclusivity of contract terms, contract clauses, rates, rate spans, rate sheets and digital documents (templates). Embodiments include facilitation of search, selection, and/or assembly of contract terms, clauses etc with or without modifications, and/or with or without review and/or approval. Embodiments include versioning control, post formation amendment, expiration and/or renewal management.

### RELATED APPLICATION

The present application is a continuation-in-part application of U.S. Non-provisional patent application Ser. No. 11/365,748, titled “Electronic Contracting”, filed on Feb. 28, 2006, and claims priority to the Ser. No. 11/365,748 application.

### TECHNICAL FIELD

Embodiments of the present invention relate to the field of data processing, and, in particular, to methods and apparatuses for facilitating the creation of digital contracts, such as digital health care contracts.

### BACKGROUND

With advances in integrated circuit, microprocessor, networking, and communication technologies, an increasing number of devices, in particular, digital computing devices, are being interconnected. This increased interconnectivity of computing devices has laid the groundwork for a communication infrastructure particularly well suited for digital communications between such computing devices. More specifically, the increased interconnectivity of computing devices has led to the increased adoption of digital documents.

In the past, digital documents, including digital contracts were limited to digital reproductions of paper-based contracts. Over time, however, computer based applications have grown increasingly sophisticated enabling the formation (drafting), and analysis (including editing) of digital contracts.

### BRIEF DESCRIPTION OF THE DRAWINGS

Embodiments of the present invention will be readily understood by the following detailed description in conjunction with the accompanying drawings. To facilitate this description, like reference numerals designate like structural elements. Embodiments of the invention are illustrated by way of example and not by way of limitation in the figures of the accompanying drawings.

FIG. 1 illustrates a digital contract terms selection and assembly system in accordance with an embodiment of the present invention;

FIG. 2 illustrates a digital rates selection and assembly system in accordance with an embodiment of the present invention;

FIG. 3 illustrates a digital contract assembly system in accordance with an embodiment of the present invention;

FIG. 4 illustrates an exemplary computer system suitable for use as a contract formation system in accordance with an embodiment of the present invention; and

FIG. 5 illustrates a flowchart of a digital contract formation method in accordance with an embodiment of the present invention.

### DETAILED DESCRIPTION OF EMBODIMENTS OF THE INVENTION

In the following detailed description, reference is made to the accompanying drawings which form a part hereof wherein like numerals designate like parts throughout, and in which is shown by way of illustration embodiments in which the invention may be practiced. It is to be understood that other embodiments may be utilized and structural or logical changes may be made without departing from the scope of the present invention. Therefore, the following detailed description is not to be taken in a limiting sense, and the scope of embodiments in accordance with the present invention is defined by the appended claims and their equivalents.

The description is presented, in part, in terms of operations performed by a processor-based device, using terms such as selecting, assembling, receiving, determining, rendering, displaying, and the like, consistent with the manner employed by those skilled in the art. Quantities may take the form of electrical, magnetic, or optical signals capable of being stored, transferred, combined and/or otherwise manipulated through mechanical, electrical, and/or optical components of a processor-based device.

Various operations may be described as multiple discrete steps in turn, in a manner that may be helpful in understanding embodiments of the present invention; however, the order of description should not be construed to imply that these operations are order dependent.

For the purposes of the present invention, the phrase “A/B” means A or B. For the purposes of the present invention, the phrase “A and/or B” means “(A), (B), or (A and B)”. For the purposes of the present invention, the phrase “at least one of A, B, and C” means “(A), (B), (C), (A and B), (A and C), (B and C), or (A, B and C)”. For the purposes of the present invention, the phrase “(A)B” means “(B) or (AB)” that is, A is an optional element.

The description may use the phrases “in an embodiment,” or “in embodiments,” which may each refer to one or more of the same or different embodiments. Furthermore, the terms “comprising,” “including,” “having,” and the like, as used with respect to embodiments of the present invention, are synonymous.

In various embodiments of the invention, a method and apparatus for composing a digital contract is provided. In exemplary embodiments of the present invention, a computer system may be employed to facilitate contracting parties such as health care payers (e.g., “users”) in creating digital health care provider contracts. In the case of a digital health care contract, the digital contract may, for example, contain all of the provisions, conditions, and terms of operation of a pension or health or welfare plan. In the following description including the claims, unless further particularized or otherwise noted, the term “digital document” is intended to refer to a broad class of digital document types including but not limited to any file produced by a computer application embodying a contract, whether or not they comprise text, binary, or otherwise encoded form.

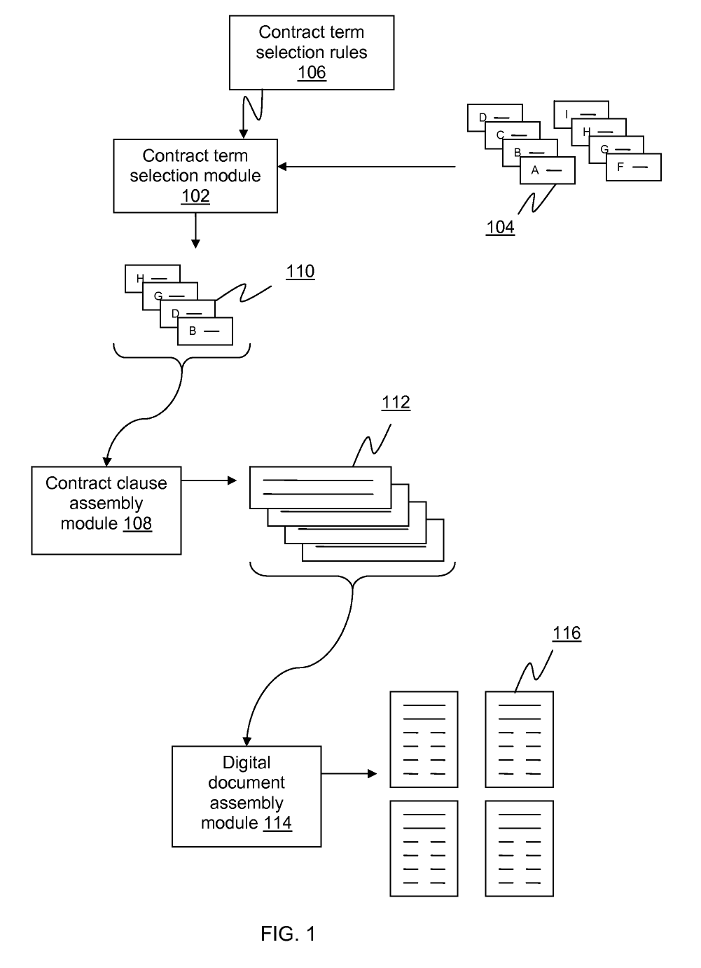

FIG. 1 is a diagram illustrating a system in accordance with an embodiment of the present invention. A contract term selection module 102 may be provided to facilitate the selection, for example, by a user, of one or more digital contract terms from a plurality of contract terms 104. In various embodiments of the present invention the plurality of digital contract terms may be stored in one or more databases. In such an embodiment, a suitable database may be a relational database.

In various embodiments of the present invention, the term “contract term” is intended to refer to any word, phrase, or expression which relates to a particular matter. A contract term may, for example, have to do with amendments, expenses, representations, covenants, effective dates, restrictions, withdrawals, and the like. More specifically, in connection with a health care provider contract, a contract term may relate to payments, benefits, claims, exclusions, billings, authorizations, and the like.

In various embodiments, contract terms 104 may have associated meta data (not shown). The meta data may include descriptive and/or associated data, e.g. whether a contract term should be use in conjunction with one or more other contract terms, whether a contract term and one or more other contract terms are mutually exclusive and cannot be used together, or whether the use and/or modification of a contract term requires one or more approvals, and identification(s) of the approval party or parties.

In an embodiment of the present invention, contract term selection module 102 may be adapted to facilitate a user in selecting one or more digital contract terms in accordance with one or more digital contract term selection rules 106. Thus, the contract term selection rules 106 may, for example, require one or more digital contract terms to be selected or not selected based on a selection of one or more digital contract terms. In such an embodiment, the selection of one or more contract terms may be dependent on the selection and/or exclusion of other contract term or terms (e.g., a “dependency”). In various embodiments of the present invention the contract term selection rules 106 may be stored as part of the meta data of the contract terms or separately in one or more databases.

In various embodiment of the present invention, contract term selection module 102 may be adapted to automatically select one or more digital contract terms based on a user's selection of one or more other digital contract terms. In an embodiment of the present invention, contract term selection module 102 may apply contract term selection rules 106 to automatically select one or more digital contract terms. In various embodiments, the automatic selections may be based at least in part, e.g., on the requisite, conjunctive, and/or exclusive requirements described in the associated meta data. In various embodiments, contract term selection module 102 may be configured to allow a user to edit and/or approve selected contract terms.

In an embodiment of the present invention, contract clause assembly module 108 is equipped to facilitate the user in assembling selected digital contract terms 110 to form digital contract clauses 112. In various embodiments of the present invention, the term “contract clause” is intended to broadly refer to any separate section, distinct article, or provision of a contract. According to an embodiment of the present invention, the selected digital contract terms 110 may be selected by the user. In another embodiment of the present invention, the selected digital contract terms 110 may be automatically selected by contract term selection module 102. In embodiments of the present invention, contract clause assembly module 108 may be provided to assemble selected digital contract terms 110 to form the one or more digital contract clauses 112. In various embodiments, the assembly whether via user selection or automatic may be performed in accordance with digital contract clause assembly rules (not shown), which may be integrally stored as part of the meta data of the selected contract terms or separately in one or more databases.

In various embodiments, contract clauses 112 may have associated meta data (not shown). The meta data may include descriptive and/or associated data, e.g. whether a contract clause should be use in conjunction with one or more other contract clauses, whether a contract clause and one or more other contract clauses are mutually exclusive and cannot be used together, or whether the use and/or modification of a contract clause requires one or more approvals, and identification(s) of the approval party or parties.

In various embodiments, contract clause assembly module 108 may be configured to allow a user to edit and/or approve formed digital clauses.

Once digital contract clauses 112 are formed, digital document assembly module 114 may be provided to facilitate the user in assembling digital contract clauses 112 to form digital documents 116, which as described later, may be used as basis for forming digital contracts. In various embodiments, digital documents 116 may be digital contract templates. In various embodiments, the assembly whether via user selection or automatic may be performed in accordance with digital document assembly rules (not shown), which may be integrally stored as part of the meta data of the selected contract clauses or separately in one or more databases.

In various embodiments, digital documents 116 may have associated meta data (not shown). The meta data may include descriptive and/or associated data, e.g. whether a digital document should be use in conjunction with one or more other digital document, whether a digital document and one or more other digital documents are mutually exclusive and cannot be used together, or whether the use and/or modification of a digital document requires one or more approvals, and identification(s) of the approval party or parties.

In various embodiments, digital document assembly module 114 may be configured to allow a user to edit and/or approve formed digital documents/contract templates.

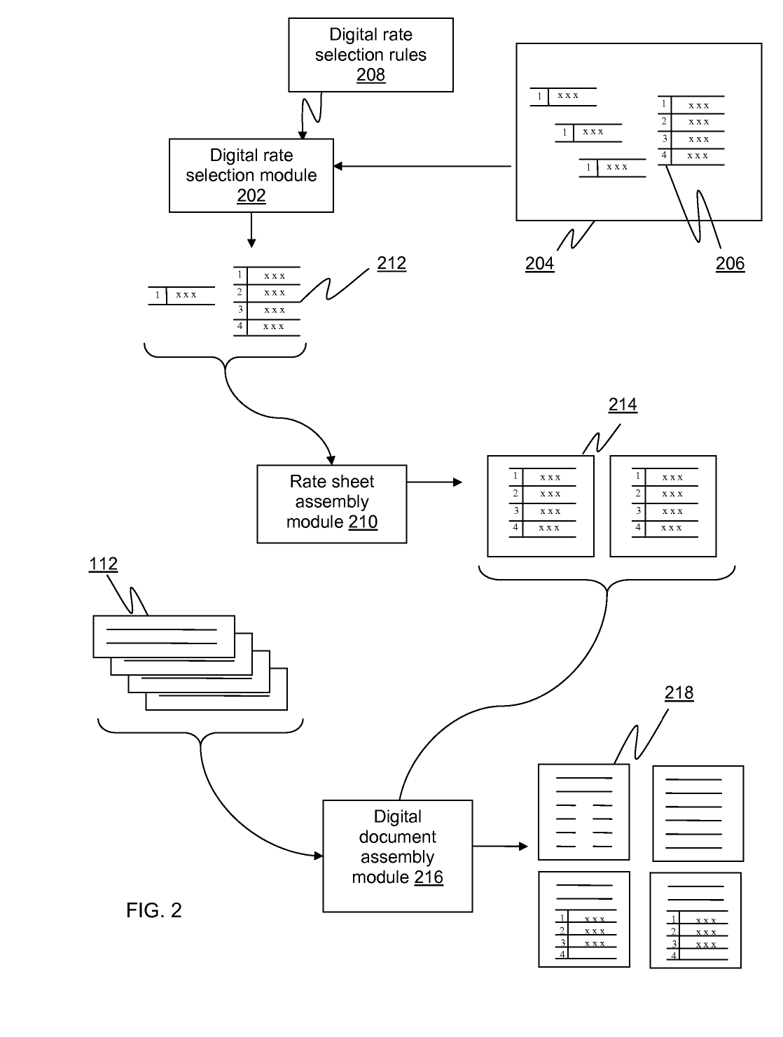

As shown in FIG. 2, in a further embodiment of the present invention, digital rate selection module 202 is provided to facilitate selecting one or more digital rates (i.e., “fees” or “premiums”) from a plurality of digital rates 204. In various embodiments of the present invention, the term “rate” is intended to broadly refer to any charge, payment, or price fixed according to a ratio, scale, or standard. More specifically, in such an embodiment, the term “rate” may broadly refer to an insurance rate. In various embodiments of the present invention, the digital rates may be organized into one or more rate spans 206. In various embodiments of the present invention, the term “rate span” is intended to broadly refer to any extent or measure between two rates, for example, as in a range or list. In various embodiments, the selection whether via user selection or automatic may be performed in accordance with digital rate selection rules (not shown), which may be integrally stored as part of the meta data of the digital rates or separately in one or more databases.

In various embodiments, digital rates 204 or rate spans 206 may have associated meta data (not shown). The meta data may include descriptive and/or associated data, e.g. whether a digital rate or rate span should be use in conjunction with one or more other digital rate or rate span, whether a digital rate or rate span and one or more other digital rates or rate spans are mutually exclusive and cannot be used together, or whether the use and/or modification of a digital rate or rate span requires one or more approvals, and identification(s) of the approval party or parties.

In various embodiments, digital rate selection module 202 may be configured to allow a user to edit and/or approve selected digital rates or rate spans.

In accordance with another embodiment of the present invention, digital rate selection module 202 may be further adapted to facilitate a user in selecting one or more digital rates or rate spans based at least in part on selected digital contract terms 110, in accordance with one or more digital rate or rate span selection rules 208. Digital rate or rate span selection rules 208 may, for example, require one or more digital rates or rate spans to be selected or not selected, in view of selected digital contract terms 110. Thus, in exemplary embodiments of the present invention, a rate span 206 may be limited and/or constrained by selected digital contract terms 110. In an embodiment of the present invention digital rate selection rules 208 may be stored in one or more databases.

In an embodiment of the present invention, rate sheet assembly module 210 is provided to facilitate assembling selected digital rates 212 to form one or more digital rate sheets 214. In exemplary embodiments of the present invention, digital rate sheets 214 may list accepted fees or established allowances for specified medical procedures and/or specified professionals of a contracting provider. For example, as used in medical care plans, digital rate sheets 214 may represent the maximum amounts a program will pay for specified procedures and/or specified physicians, nurses of particular experience/level. In various embodiments, the assembly whether via user selection or automatic may be performed in accordance with digital rate sheet assembly rules (not shown), which may be integrally stored as part of the meta data of the selected digital rates (rate spans) or separately in one or more databases.

In various embodiments, digital rate sheets 214 may have associated meta data (not shown). The meta data may include descriptive and/or associated data, e.g. whether a digital rate sheet should be use in conjunction with one or more other digital rate sheet, whether a digital rate sheet and one or more other digital rate sheets are mutually exclusive and cannot be used together, or whether the use and/or modification of a digital rate sheet requires one or more approvals, and identification(s) of the approval party or parties.

In various embodiments, rate sheet assembly module 210 may be configured to allow a user to edit and/or approve formed digital rate sheets.

In an embodiment of the present invention, digital document assembly module 216 may be provided to assemble the one or more digital contract clauses 112 and the one or more digital rate sheets 214 to form the one or more digital documents 218. In various embodiments, the assembly whether via user selection or automatic may be performed in accordance with digital document assembly rules (not shown), which may be integrally stored as part of the meta data of the selected contract clauses and/or digital rate sheets, or separately in one or more databases.

In various embodiments, digital documents 218 may have associated meta data (not shown). The meta data may include descriptive and/or associated data, e.g. whether a digital document should be use in conjunction with one or more other digital document, whether a digital document and one or more other digital document are mutually exclusive and cannot be used together, or whether the use and/or modification of a digital document requires one or more approvals, and identification(s) of the approval party or parties.

In various embodiments, digital document assembly module 216 may be configured to allow a user to edit and/or approve formed digital documents.

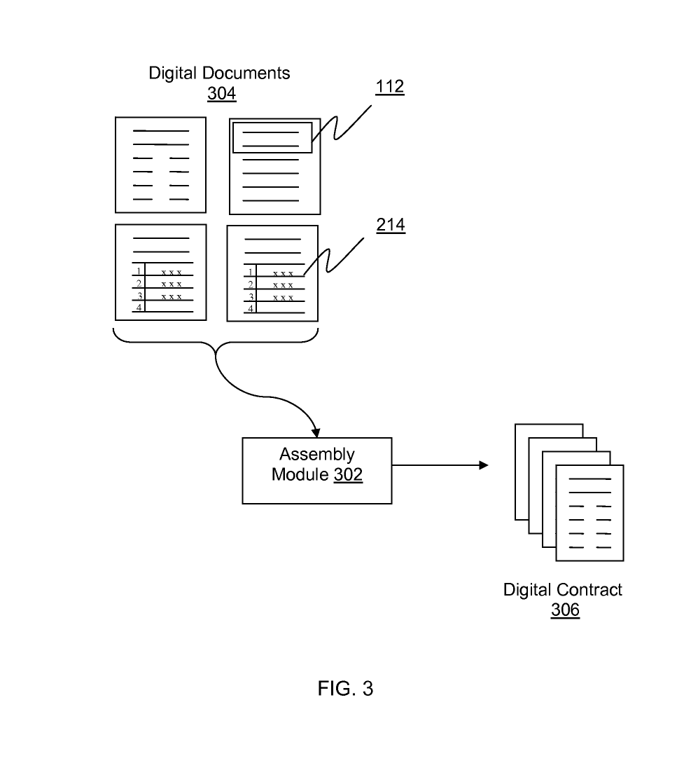

FIG. 3 illustrates a digital contract assembly system in accordance with an embodiment of the present invention. As shown, assembly module 302 may be provided to facilitate a user in assembling one or more digital documents 304 to form a digital contract 306. In various embodiments of the present invention digital documents 304 may include one or more digital rate sheets 214 and/or one or more digital contract clauses 112.

In an embodiment, a digital document may include one or more terms directly, independent of the one or more terms making up one or more clauses. In an embodiment of the present invention, a digital document may include at least one clause or term, wherein the clause may include at least one term. A document may include a rate sheet, which in turn includes at least one rate. In various embodiments, the assembly whether via user selection or automatic may be performed in accordance with digital contract assembly rules (not shown), which may be integrally stored as part of the meta data of the selected digital documents or separately in one or more databases.

In various embodiments, digital contracts 306 may have associated meta data (not shown). The meta data may include descriptive and/or associated data, e.g. parties, formation dates, expiration of the contracts, whether the contracts may be renewed, whether the renewal may be made with or without review and/or approval, and if review and/or approval is needed, the identification(s) of the review/approval party or parties.

In various embodiments, assembly module 302 may be configured to allow a user to edit and/or approve formed digital contracts. In various embodiments, assembly module 302 may further be configured to facilitate post-contracting modifications to formed contracts, i.e., post contracting amendments. Similarly, the post contracting amendments may have associated meta data containing information similar to those earlier described for contract terms, clauses, documents, rates, rate spans, rate sheets and contracts.

In various embodiments, implementations of one or more of contract terms 104, contract clauses 112, digital documents 116, digital rates 204 or rate spans 206, digital rate sheets 214, digital documents 218, and digital contracts 306 may be versioned, e.g. internally stored in a base and delta form or otherwise with their versions tracked.

For these embodiments, corresponding one(s) of contract term selection module 102, contract clause assembly module 108, digital document assembly module 114, digital document assembly module 114, digital rate selection module 202, rate sheet assembly module 210, digital document assembly module 216 and assembly module 306 may be further configured to allow a user to view and compare different versions of contract terms 104, contract clauses 112, digital documents 116, digital rates 204 or rate spans 206, digital rate sheets 214, digital documents 218, and digital contracts 306 respectively. In various embodiments, the viewing and comparing includes highlighting the differences between the different versions. In various embodiments, the highlighting comprises highlighting of the substantive difference in terms, clauses, rates, rate spans, and/or rate sheets, and not a straight forward textual difference of type offered by e.g., a word processing application.

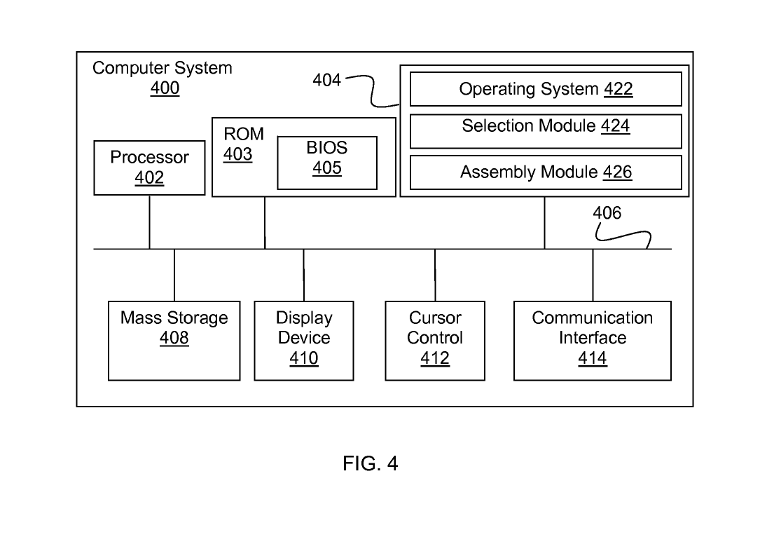

FIG. 4 illustrates an exemplary computer system in accordance with embodiments of the present invention. As shown, example computer system 400 includes processor 402, ROM 403 including basic input/output system (BIOS) 405, and system memory 404 coupled to each other via “bus” 406. Also coupled to “bus” 406 are nonvolatile mass storage 408, display device 410, cursor control device 412, and communication interface 414. During operation, memory 404 may also include working copies of operating system 422, selection module 424, and assembly module 426. In various embodiments, memory 404 may also include one or more applications (not shown), with which selection module 424 and assembly module 426 are coupled. In various embodiments of the present invention, selection module 424 may include contract term and contract rate selection logic in accordance with embodiments of the present invention to facilitate a user in selecting contract terms and contract rates for assembling into a digital contract. In various embodiments of the present invention, assembly module 426 may include contract clause, digital document, contract rate sheet, and contract assembly logic in accordance with embodiments of the present invention to facilitate a user in assembling contract clauses, digital documents, and rate sheets. Assembly module 426 may be further adapted to assemble the digital documents into a digital contract. In other embodiments, computer system 400 may also include one or more databases for storing the digital contract terms, clauses, digital documents, digital contract rates, rate spans and digital contracts, as well as the associated meta data, where applicable.

In various embodiments, selection module 424 may include search facilities to allow search for various contract terms, clauses, digital documents, rates, rate spans, rate sheets and/or contracts by their contents and/or their meta data.

In various embodiments, assembly module 426 may be further configured to track the expiration and/or renewal dates of the contract terms, clauses, digital documents, rates, rate spans, and/or contracts, provide various reminders of the expirations and renewals.

In various embodiments, various aspects of the selection module 424 and/or assembly module 426 may be disposed on multiple networked or otherwise coupled computer systems instead.

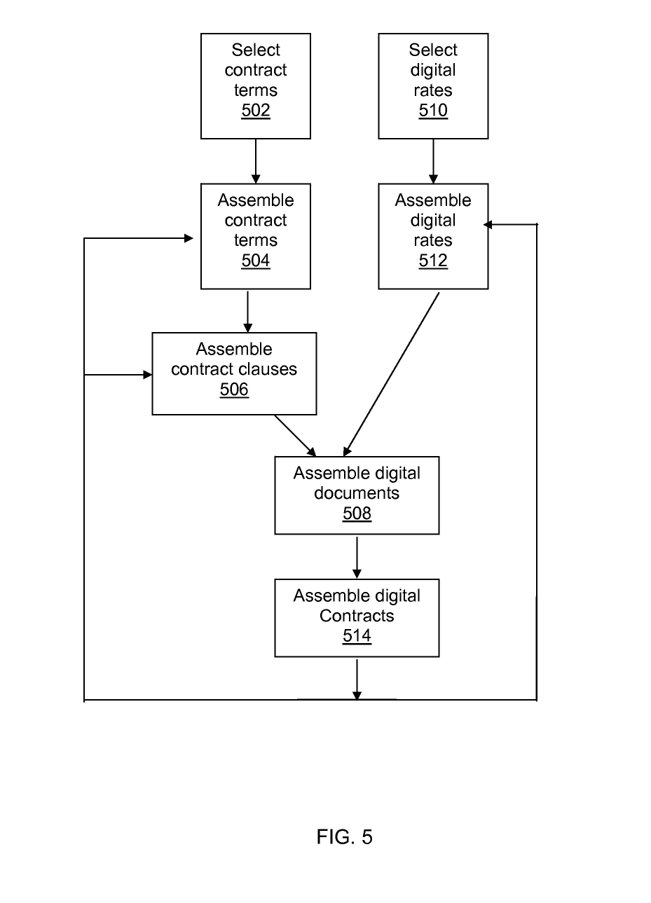

FIG. 5 illustrates a flowchart of a computer implemented method for composing a digital contract in accordance with an embodiment of the present invention. In block 502, one or more digital contract terms are selected from a plurality of digital contract terms. According to an embodiment of the present invention, the plurality of contract terms may be stored in a database of contract terms. In another embodiment of the present invention the selection of contract terms may be governed by selection rules. In such an embodiment, the selection rules may, for example, require one or more digital contract terms to be selected, or not selected, in view of the selection of one or more digital contract terms. In various embodiments, one or more digital contract terms may be automatically selected based on a user selection of one or more other digital contract terms. The selection of the contract term(s) may be performed with or without modification to the selected terms, and they may also be selected with or without review and/or approval as required by the review and approval information stored in the meta data.

In an embodiment of the present invention, the digital contract terms are assembled to form one or more digital contract clauses (block 504). In an embodiment, the digital contract clauses may be created by assembling user selected and automatically selected digital contract terms. The formation of the contract clause(s) may be performed with or without modification to the formed clauses, and they may also be formed with or without review and/or approval as required by the review and approval information stored in the meta data.

Once the digital contract terms are assembled into digital contract clauses, the digital contract clauses may be assembled to form one or more digital documents (block 506). The formation of the digital documents may be performed with or without modification to the formed documents, and they may also be formed with or without review and/or approval as required by the review and approval information stored in the meta data.

In a further embodiment of the present invention, the digital documents may then be assembled to form a digital contract (block 508). In one embodiment of the present invention, the digital contract may be a health care provider contract. The formation of the digital contract(s) may be performed with or without modification to the formed contracts, and they may also be formed with or without review and/or approval as required by the review and approval information stored in the meta data.

In another embodiment of the present invention, one or more digital contract rates are selected from a plurality of digital rates (block 510). According to an embodiment of the present invention, the plurality of digital rates may be stored in a database. In another embodiment of the present invention, the plurality of digital rates may be organized into one or more rate spans. In an embodiment of the present invention the selection of digital rates may be governed by digital rate selection rules. In such an embodiment, the selection rules may require one or more digital contract rates to be selected, or not selected, in view of the selection of one or more digital contract terms. The selection of the rates or rate spans may be performed with or without modification to the selected rates or rate spans, and they may also be formed with or without review and/or approval as required by the review and approval information stored in the meta data.

Once contract rates or rate spans have been selected, the user may assemble at least the user selected digital contract rates to form one or more digital rate sheets (block 512). The formation of the rate sheets may be performed with or without modification to the formed rate sheets, and they may also be formed with or without review and/or approval as required by the review and approval information stored in the meta data.

The digital rate sheets may be assembled together with the digital documents to form one or more digital contracts. The formation of the contracts may be performed with or without modification to the formed contracts, and they may also be formed with or without review and/or approval as required by the review and approval information stored in the meta data.

In alternate embodiments, one or more digital contract terms may be directly included in a document absent formation into at least one clause. Similarly, one or more digital contract terms, clauses, documents, rates, rate spans, rate sheets may be directly included in a contract absent formation into one or more intermediate entities, i.e., clauses, documents, and rate sheets.

After formation, if permissible, digital contracts may be modified or amended. The modification and/amendment may be performed with or without review and/or approval as required by the review and approval information stored in the meta data. If permissible, digital contracts may be renewed. Similarly, the renew may be performed with or without review and/or approval as required by the review and approval information stored in the meta data. If applicable.

Although certain embodiments have been illustrated and described herein for purposes of description of the preferred embodiment, it will be appreciated by those of ordinary skill in the art that a wide variety of alternate and/or equivalent embodiments or implementations calculated to achieve the same purposes may be substituted for the embodiments shown and described without departing from the scope of the present invention. Those with skill in the art will readily appreciate that embodiments in accordance with the present invention may be implemented in a very wide variety of ways. This application is intended to cover any adaptations or variations of the embodiments discussed herein. Therefore, it is manifestly intended that embodiments in accordance with the present invention be limited only by the claims and the equivalents thereof.

What is claimed is:

1. A computer implemented method for composing a digital contract, comprising:
facilitating a user, by one or more computing devices, in selecting one or more digital contract terms from a plurality of digital contract terms;
assembling by one or more computing devices at least one of the one or more digital contract terms to form one or more digital documents; and
assembling by one or more computing devices at least one of the one or more digital documents to form the digital contract;
wherein at least one of the digital contract terms, the digital contract documents or the digital contract having associated meta data describing review or approval requirement for use or modification of the corresponding digital contract term, digital contract document, or digital contract.

2. The method of claim 1, wherein the digital contract comprises a digital health plan provider contract.

3. The method of claim 1, wherein the method further comprises
assembling by one or more computing devices at least one of the one or more user selected digital contract terms to form one or more digital contract clauses for assembly into the one or more digital documents, wherein at least one of the digital contract terms or the digital contract clauses having associated meta data describing review or approval requirement for use or modification of the corresponding digital contract term or digital contract clause.

4. The method of claim 1, wherein the method further comprises
facilitating a user, by one or more computing devices, in selecting one or more digital rates from a plurality of digital rates; and
assembling by one or more computing devices at least one of the user selected one or more digital rates to form one or more digital rate sheets;
wherein at least one of the digital rates or the digital rate sheets having associated meta data describing review or approval requirement for use or modification of the corresponding digital rate or rate sheet.

5. The method of claim 4, wherein the plurality of digital rates comprises a digital span of rates, wherein at least one of the digital rates or the digital rate spans having associated meta data describing review or approval requirement for use or modification of the corresponding digital rate or rate span.

6. The method of claim 4, wherein the method further comprises
assembling by one or more computing devices at least one of the one or more user selected digital rate sheets for assembly into the one or more digital documents, wherein at least one of the digital rate sheets or the digital documents having associated meta data describing review or approval requirement for use or modification of the corresponding digital rate sheet or document.

7. The method of claim 4, wherein said facilitating of a user in selecting one or more digital rates comprises facilitating a user, by one or more computing devices, in selecting one or more digital rates based at least in part on the selected one or more digital contract terms, in accordance with one or more digital rate selection rules, the selected one or more digital contract terms having corresponding associated meta data describing the one or more digital rate selection rules.

8. The method of claim 7, wherein at least one of the digital rate selection rules requires one or more digital rates to be selected or not selected, in view of the selected one or more digital contract terms.

9. The method of claim 1, wherein said facilitating of a user in selecting second one or more digital contract terms comprises facilitating a user, by one or more computing devices, in selecting one or more digital contract terms based at least in part on one or more first selected digital contract terms, in accordance with one or more digital contract term selection rules, the one or more first selected digital contract terms describing the one or more digital contract term selection rules.

10. The method of claim 1, wherein the method further comprises automatically selecting by one or more computing devices second one or more digital contract terms based on the user selection of first one or more other digital contract terms, the user selected first one or more digital contract terms having associated meta data describing automatic selection of the second one or more digital contract terms.

11. The method of claim 1 further comprising facilitating by one or more computing devices modifying or amending the digital contract post formation.

12. The method of claim 11 further comprising facilitating by one or more computing devices renewal of the digital contract if the digital contract is eligible for renewal, the digital contract having associated meta data describing whether the contract is eligible for renewal.

13. The method of claim 12 further comprising facilitating by one or more computing devices review or approval of the renewal if review or approval is required for the renewal, the digital contract further having associated meta data describing whether review or approval is required for renewal.

14. A computer implemented method for composing a digital contract, comprising:
facilitating a user, by one or more computing devices, in selecting one or more digital contract terms from a plurality of digital contract terms;
assembling by one or more computing devices at least one of the one or more digital contract terms to form one or more digital documents; and
assembling by one or more computing devices at least one of the one or more digital documents to form the digital contract;
wherein at least one of the digital contract terms or the digital contract documents having associated meta data describing inter-dependency or mutual exclusivity of the corresponding digital contract term with one or more other contract terms, or the corresponding digital contract document with one or more other digital documents.

15. The method of claim 14, wherein the method further comprises
assembling by one or more computing devices at least one of the one or more user selected digital contract terms to form one or more digital contract clauses for assembly into the one or more digital documents, wherein at least one of the digital contract terms or the digital contract clauses having associated meta data describing inter-dependency or mutual exclusivity of the corresponding digital contract term with one or more other contract terms, or the corresponding digital contract clause with one or more other digital clauses.

16. The method of claim 14, wherein the method further comprises
facilitating a user, by one or more computing devices, in selecting one or more digital rates from a plurality of digital rates; and
assembling by a computing device at least one of the user selected one or more digital rates to form one or more digital rate sheets;
wherein at least one of the digital rates or the digital rate sheets having associated meta data describing inter-dependency or mutual exclusivity of the corresponding digital rate with one or more other digital rates, or the corresponding digital rate sheets with one or more other digital rate sheets; or at least one of the digital rate sheets having digital rates particularized to a subset of professionals of a provider to be contracted with the digital rate sheet.

17. The method of claim 14 further comprising facilitating modifying or amending the digital contract post formation.

18. A system comprising:
one or more processors;
a selection module operated by one or more of the one or more processors to facilitate a user in selecting one or more digital contract terms from a plurality of digital contract terms, at least one of the digital contract terms having associated meta data describing review or approval requirement for use or modification of the corresponding digital contract term; and
an assembly module operated by one or more of the one or more processors to facilitate a user in assembling at least one of the one or more user selected digital contract terms to form one or more digital documents, and to facilitate a user in assembling at least one of the one or more digital documents to form the digital contract, at least one of the digital documents or digital contract having associated meta data describing review or approval requirement for use or modification of the corresponding digital document or digital contract.

19. The system of claim 18, wherein the assembly module is further operated by one or more of the one or more processors to facilitate a user in assembling at least one of the one or more digital contract terms to form one or more digital contract clauses for assembly into the one or more digital documents, at least one of the digital contract clauses having associated meta data describing review or approval requirement for use or modification of the corresponding digital contract clauses.

20. The system of claim 18, wherein the selection module is further operated by one or more of the one or more processors to facilitate a user in selecting one or more digital rates from a plurality of digital rates and the assembly module is further operated by the processor to facilitate assembling at least one of the user selected one or more digital rates to form one or more digital rate sheets, at least one of the digital rates or digital rate sheets having associated meta data describing review or approval requirement for use or modification of the corresponding digital rate or digital rate sheet.

21. The system of claim 20, wherein the plurality of digital rates comprises a digital span of rates.

22. The system of claim 20, wherein the assembly module is further operated by one or more of the one or more processors to facilitate a user in assembling at least one of the one or more digital rate sheets for assembly into the one or more digital documents, at least one of the digital rate sheets or digital documents having associated meta data describing review or approval requirement for use or modification of the corresponding digital rate sheet or digital document.

23. The system of claim 19, wherein the selection module is further operated by one or more of the one or more processors to facilitate a user in searching for one or more digital contract terms, one or more digital contract clauses, one or more digital documents or one or more digital contracts.

24. The system of claim 19, wherein the assembly module is further operated by one or more of the one or more processors to facilitate a user in modifying a digital contract term, a digital contract clause, a digital document, or the digital contract.

25. The system of claim 19, wherein the assembly module is further operated by one or more of the one or more processors to facilitate a user in reviewing or approving selecting or modifying of one or more digital contract terms, one or more digital contract clauses or one or more digital documents.

26. A system, comprising:
one or more processors;
a selection module operated by one or more of the one or more processors to facilitate a user in selecting one or more digital rates from a plurality of digital rates, at least one of the digital rates having associated meta data describing inter-dependency or mutual exclusivity of the corresponding digital rate with one or more other digital rates; and
an assembly module operated by one or more of the one or more processors to facilitate a user in assembling at least one of the user selected digital rates to form one or more digital rate sheets, to facilitate a user in assembling at least one of the one or more digital rate sheets to form one or more digital documents, and to facilitate a user in assembling at least one of the one or more digital documents to form the digital contract, at least one of the digital rate sheets or the digital documents having associated meta data describing inter-dependency or mutual exclusivity of the corresponding digital rate sheet with one or more other digital rate sheet or of the corresponding digital document with one or more other digital documents.

27. The system of claim 26, wherein the plurality of digital rates comprises a digital span of rates.

28. The system of claim 26, wherein the selection module is further operated by one or more of the one or more processors to facilitate a user in searching for one or more digital rates, one or more digital rate sheets, one or more digital documents or the digital contract.

29. The system of claim 26, wherein the assembly module is further operated by one or more of the one or more processors to facilitate a user in modifying a digital rate, a digital rate sheet, a digital document, or the digital contract.

30. The system of claim 26, wherein the assembly module is further operated by one or more of the one or more processors to facilitate a user in reviewing or approving selecting or modifying of one or more digital rates, one or more digital documents or the digital contract.
